(19) United States
(12) Patent Application Publication
(10) Pub. No.: US 2025/0138893 A1
(43) Pub. Date: May 1, 2025

(54) SYSTEM AND METHOD FOR SCHEDULE MESSAGE AND AUTOMATED SMART CONTRACTS IN BLOCKCHAIN NETWORK

(71) Applicants: Yu Heng Cheung, Cambridge (GB); Kwok Wai Cheung, Cambridge (GB)

(72) Inventors: Yu Heng Cheung, Cambridge (GB); Kwok Wai Cheung, Cambridge (GB)

(73) Assignees: Yu Heng Cheung, Cambridge (GB); Kwok Wai Cheung, Cambridge (GB)

(21) Appl. No.: 18/929,740

(22) Filed: Oct. 29, 2024

(30) Foreign Application Priority Data
Oct. 31, 2023 (GB) GB2316688.7

(51) Int. Cl. G06F 9/50

(52) U.S. Cl. CPC G06F 9/5027

(57) ABSTRACT

This invention describes a novel blockchain network system and method tailored for managing the time and logic sensitive scheduling operations, specifically allowing the scheduling of executions in the future. The novel blockchain network system and scheduling method is a Layer-1 solution that preserves the open, distributed, decentralised, verifiable, robust, immutable and secure data archiving properties of blockchain network and is distinguished from other Layer-2 protocols built on top of Layer-1 blockchain networks. With schedule messages, self-invoking contracts can be realised to carry out recurring tasks, updates, or transactions without external activation or approval. Self-invoking smart contracts can be used to create digital tokens with expiration time, universal basic income framework which is self-sustainable without continuous funding injection, periodic increment or decrement in token amount similar to the interest rate payment, and financial derivative tokens which is analogous to options, futures, forwards, warrants, and hybrid derivatives in the financial market.

### CROSS-REFERENCE TO RELATED APPLICATION

This non-provisional application claims priority on Patent Application Number GB2316688.7 filed in United Kingdom on Oct. 31, 2023, the entire contents of which are hereby incorporated by reference.

### TECHNICAL FIELD

This invention relates to blockchain system and method capable of processing schedule message and hosting automated smart contracts.

### BACKGROUND OF THE INVENTION

A blockchain is an open, distributed, decentralised, verifiable, robust, immutable and secure data archiving system for recording various types of data which can continue to accumulate over time. The working principles and details of some operational examples such as Bitcoin and Ethereum are well-known in the literature. Advancement in blockchain technology catalysed the profusion of cryptocurrencies.

Virtual machine and smart contracts have become an integral part of most blockchain networks such as Ethereum and Solana. A smart contract is a piece of executable code created by users and stored in the virtual machine of the blockchain for execution. A variety of tools for smart contract developments and executions have been deployed, for example, Solidity and the Ethereum Virtual Machine (EVM).

Although existing smart contracts and virtual machine systems facilitate a variety of functions, one serious limitation of these blockchain network systems is their inability to schedule messages and automate smart contract executions based on a predefined schedule or logic. Since all virtual machines are deterministic for consensus and security, transactions accepted as part of the blockchain must be immediately executed. An external solution is currently required for the scheduling system. A discrepancy could occur if a transaction scheduled for future is accepted as part of the blockchain ledger.

Multiple external protocols are therefore formulated to facilitate the scheduling of messages and automatic execution of smart contracts, such as the Ethereum Alarm Clock (Merriam, P. (2015). Ethereum Alarm Clock Documentation. URL: https://media. readthedocs.org/pdf/ethereum-alarm-clockservice/latest/ethereum-alarm-clock-service.pdf.) and the Chainlink Automation (Breidenbach, L., Cachin, C., Chan, B., Coventry, A., Ellis, S., Juels, A., . . . & Zhang, F. (2021). Chainlink 2.0: Next steps in the evolution of decentralized oracle networks. Chainlink Labs, 1, 1-136). These protocols would send the scheduled transactions at specified time on behalf of the users to interact with the blockchain network in the future.

Ethereum Alarm Clock is a system for scheduling Ethereum transactions by setting up smart contracts over the EVM. Users would rely on service providers of the Ethereum Alarm Clock system for executing their transactions at preferred times. The scheduled transactions are not recorded on the blockchain, and there is no guarantee that the service providers would execute the scheduled transactions.

Chainlink Automation is a centralised solution for invoking the functions of smart contract. Chainlink operates as an external service provider to carry out user's conditional execution of smart contracts. While Chainlink can mimic smart contract automation, it is not a distributed and fault-tolerant ledger like the blockchain, but a decentralised oracle network that facilitates the interaction between smart contracts on various blockchains and external data sources. Therefore, the entire operation is not recorded on the blockchain network and hidden from the users. Despite Chainlink employing several security measures such as cryptographic security, it is not immune to potential system failures. These could arise from oracle manipulation, smart contract vulnerabilities, off chain computation vulnerability, centralization risks, network congestion, Sybil attacks, data source failures, economic incentive failures, and cryptographic failures. These vulnerabilities could potentially lead to incorrect data input, disruptions, or undesired outcomes in the smart contracts utilizing Chainlink's services. There is also significant cost and complexity involved in carrying out the off-chain automation task.

It is apparent that there is a great need to revise the blockchain and smart contract architecture to provide native, distributed, decentralised, open, verifiable, fault-tolerant support directly on the blockchain ledger for the scheduling and execution of messages that are based on time or logic. Other important reasons why a tight integration of the scheduling and automatic execution of smart contracts with the open, distributed blockchain ledger is essential to certain applications will become apparent in the following detailed descriptions.

### SUMMARY OF THE INVENTION

One embodiment introduces a novel blockchain network system and method tailored for time and logic sensitive scheduling operations, specifically allowing the future execution of scheduled blockchain messaging and self-invoking smart contracts in a distributed and decentralised blockchain network system. The novel blockchain network system and scheduling method is a Layer-1 solution that is distinguished from other Layer-2 protocols built on top of Layer-1 blockchain networks. The described system is a novel, independent blockchain network system that could either function independently or used to modify and enhance other existing networks.

In a subsequent embodiment, the described system is composed of nodes (also called servers) that contains one or more of the following three basic modules shown in FIG. 1: Message Processing and Network Routing Module (MPNRM) 111, Blockchain History Module (BHM) 121 and Validator Module (VM) 131. A decentralised message scheduling system (DMSS) is embedded into the MPNRM 111 of each node, which allows the processing of a novel type of Schedule Message on the blockchain. The DMSS is realised by implementing Message Processor (MP) 1111 and Schedule Processor (SP) 1114 in each MPNRM 111. The MP can process the Schedule Message by broadcasting and accepting it into its Pending Message Pool (PMP) 1113, and the SP converts Schedule Messages into concurrent processes that can generate Transaction Messages according to time and logic conditions.

In one embodiment, Schedule Messages can be initiated by End Users 105 to interact with the described system according to the data specifications shown in FIG. 2. Smart contract codes can also be converted into Schedule Messages by the Blockchain Virtual Machine 1313. A Schedule Message can either be modifiable or non-modifiable.

In another embodiment, smart contract functions can be executed autonomously by setting up a Schedule Message which regulates how the smart contract function react to change in the machine state. Automated contracts can carry out recurring tasks, updates, or transactions without external activation or approval, thereby enhancing the level of automation and reliability in the blockchain system. A dynamic, automated, and time-aware dimension is added to the system, broadening its potential applications in sectors like finance and the Internet of Things.

In another embodiment, the smart contract with the Schedule Message can be used to create digital tokens with expiration time. Expiration time is realised by scheduling a token transfer back to a repository after a period of inactivity. None of the existing cryptocurrency systems such as Bitcoin has an expiration time. Tokens with expiration time can have profound financial and economic impacts serving as new financial instruments and monetary tools.

A subsequent embodiment of the digital tokens with expiration time includes a mechanism for renewing the expiration time. The expiration time of the transferred tokens is reset to the original value. This renewal mechanism incentivises token circulation before expiration by setting up penalty for token inactivity and accumulation. The sender and receiver of the token can be the same account.

In a related embodiment, a novel type of digital token called Regenerative Universal Basic Income (RUBI) can be created by implementing expiration time and retrieval rate for every transfer to claw back a certain percentage of tokens to the repository. This retrieval rate is analogous to the value added tax in the current taxation system that guarantees the recirculation of the tokens. The combination of expiration time and retrieval rate on digital tokens can create a recirculating stream of RUBI for redistribution to a portion or all users indefinitely. Individuals receiving the RUBI could be given a time limit (for example six months or one year) to spend their RUBI, in which a percentage (for example 5 percent) of transferred value is retrieved to the RUBI distribution repository. The time limit of the transferred RUBI will be reset after every transfer. If the RUBI is not spent entirely within the time limit, the unspent portion would be retrieved automatically by the smart contract that generate the RUBI.

In another embodiment, the smart contract with the Schedule Message can be used to create digital tokens with an automatic periodic increment or decrement in token amount. The increment and decrement are carried out automatically and periodically by the Schedule Message, and the rate of change can be adjusted by a parameter from time to time. For example, if the rate of increment is 10% for a year, each account would receive additional tokens of (account token amount*10%/365) per day, and vice versa for negative rate. This is not possible with existing cryptocurrencies since smart contracts have no custody over distributed tokens after deployment, and smart contracts cannot initiate any transactions by themselves. The automatic periodic increment can imitate interest generation for fixed deposit in the banks, and the automatic periodic decrement can serve as a negative interest rate tool for central bank authorities. The period can be a variable, from a minimum of one day to one week, one month, three months, one year or multiple years. The daily automatic increment or decrement imitates the overnight interest rate for bank deposits. This embodiment can also be used to regulate token supplies by expanding or contracting the amounts of tokens in user accounts. This is a different approach to quantitative easing or tightening by keeping the users in control of the token supplies during quantitative easing or tightening.

In another embodiment, digital tokens with expiration time can be used to create Financial Derivative Tokens (FDTs) which is analogous to options, futures, forwards, swaps, warrants, and hybrid derivatives in the financial market. Digital tokens with an expiration time can have its value calculation formula (such as Black-Sholes formula for European-style options) encoded in the contract, and individuals can trade the FDTs in a trusted, transparent and decentralised manner. FDTs can be automatically settled by scheduling a contract settlement which execute contract value calculation function at the expiration time. In another embodiment, a system for managing the FDTs is described, with functions including creation, modification and cancellation of FDTs, trading, price discovery, statistics gathering, trusted proxy for traders, insurance, and legal compliance. This system offers a transparent, open, decentralised, robust, secure and trusted trading environment for FDTs.

In another embodiment, a novel account state structure is described in the system to include an expiration time, event list and token balance for including smart contract generated tokens. The expiration time in the account state could be used to facilitate the creation of digital tokens with expiration time by providing a means to tracking expiration schedule of tokens in the account state. The event list be a data source for on chain and off-chain operations to call upon, providing additional layer of flexibility to smart contract and oracle node build upon the described blockchain network.

Other aspects and advantages of the present invention will become apparent from the following detailed description, which, when taken in conjunction with the accompanying drawings, illustrates by way of example the principles of the invention.

### BRIEF DESCRIPTION OF DRAWINGS

FIG. 1 shows the Blockchain System Architecture.

FIG. 2 shows the System Message Format.

FIG. 3 shows the Message Processing and Network Routing Module 111.

FIG. 4 shows the Pending Message Pool 1113.

FIG. 5 shows the Blockchain History Module 121.

FIG. 6 shows the Validator Module 131.

FIG. 7 shows the Consensus Algorithm.

FIG. 8 shows the Blockchain Virtual Machine 1313.

FIG. 9 shows the Account State Structure.

FIG. 10 shows the Data structure of Proposed Block B1.

FIG. 11 shows the Interaction Diagram showing End User Initiating Transaction Message TR1.

FIG. 12 shows the Flow Diagram of Transaction Message TR1.

FIG. 13 shows the Interaction Diagram Showing End User initiating Schedule Message S1.

FIG. 14 shows the Flow Diagram showing the Generation and Processing of Schedule Processes.

FIG. 15 shows the Dynamic Array Method to manage Digital Tokens with expiration time

### DETAILED DESCRIPTION

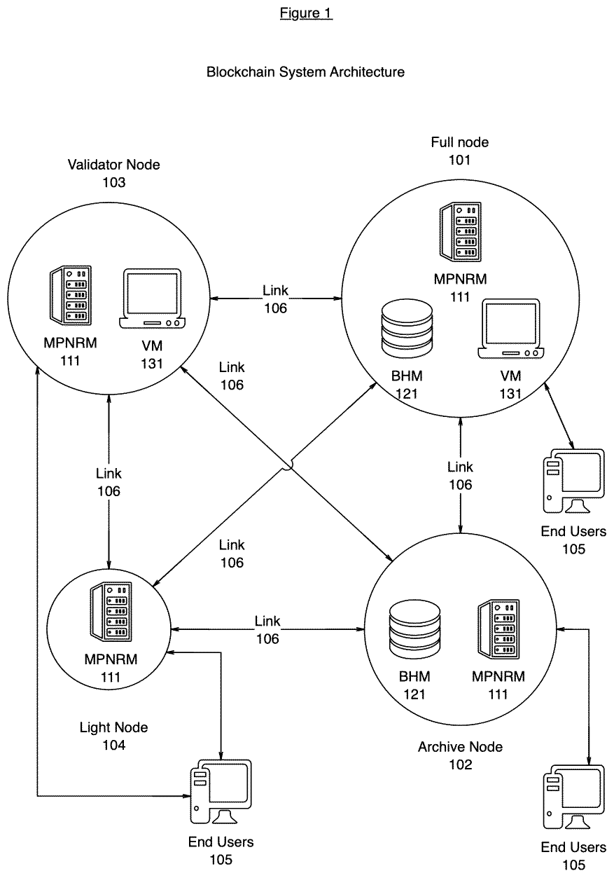

One embodiment introduces a novel blockchain network (BN) that incorporates scheduling mechanism as an integral part of the Layer-1 system architecture. The most distinguishing feature of BN is that it enables scheduling based on time or logic conditions in Layer-1. A Layer-1 network refers to a decentralised blockchain system that offers security and scalability. A Layer-2 protocol refers to a third-party integration that can be used in conjunction with a Layer-1 blockchain. BN is a Layer-1 network. The basic components of BN are called the nodes (including but not limited to Full Node (FN) 101, Archive Node (AN) 102, Validator Node (VN) 103 and Light Node (LN) 104 as shown in FIG. 1) which carry out the processing of messages and the management of the blockchain. The nodes are basically servers with different modules interconnected by communication links based on the IP network protocols. Messages are transmitted among the nodes over the underlying IP network. BN can be set up as a VPN on top of the public Internet or the various nodes of BN can simply be distributed within the public Internet.

In a subsequent embodiment, the described system is composed of nodes that contains one or more of the following three basic modules: Message Processing and Network Routing Module (MPNRM) 111, Blockchain History Module (BHM) 121 and Validator Module (VM) 131. MPNRM 111 serves to communicate and process the messages transmitted among the nodes. It also processes the transactions submitted by users in the application layer. BHM 121 stores a copy of the blockchain history. VM 131 serves to validate a new proposed block page according to consensus algorithms to be described later. Each kind of module is equipped with identical or compatible hardware and software, initialised in the same way and co-operates to give rise to the decentralised property of BN. In general, the distributed and decentralised nature of the blockchain network offers robustness and resilience against network, system or node failures, and malicious attacks.

End Users 105 (including but not limited to service providers, administrators, individual users, automated intelligent machines) can set up their own type of nodes according to their needs. Based on the combination of modules deployed, the four basic kinds of nodes are described below. Other kinds of nodes could also be allowed if they follow the communication protocols with compatible hardware and software.

A Full Node 101 contains all three modules MPNRM 111, BHM 121 and VM 131 and can be functionally independent from other nodes. It would also require the most resources in set-up and a large memory to store the perpetually growing blockchain history.

An Archive Node 102 contains only the MPNRM 111 and BHM 121. The BHM is essential for various service offerings and fulfilling the blockchain network management function such as providing account balance and transaction history.

A Validator Node 103 contains only the MPNRM 111 and VM 131. It can directly participate in the consensus validation process and earn validation rewards.

A Light Node 104 contains only the MPNRM 111 and is dependent on other nodes for blockchain processing. The main responsibility of a Light Node is to process transactions received from the End Users 105 and propagate messages among the nodes.

The Nodes communicate through Wired or Wireless Communication Links 106. The Nodes are presumed to be time synchronised to within a small fraction of a second for robustness consideration. Current Internet technology allows system clock to be synchronised with an Internet time server.

The basic operations of BN are first described, and the details will follow.

Message processing—In order to achieve the functionality of BN, messages are sent among the various components of BN and the End Users 105 to coordinate the distributed and decentralised effort. The messages are handled by the MPNRM 111 and include the following types: transaction requests, schedule requests, information requests, smart contract deployments and modifications, and consensus related messages.

Message broadcast—New transaction and schedule related messages are appended to the PMP 1113, and immediately broadcasted to all other nodes. Message processing and broadcasting are repeated recursively until all nodes in the network have received, validated, and appended the messages to its individual PMP 1113.

Execution of consensus algorithm—From time to time, a consensus algorithm is executed to determine what messages stored at the PMP 1113 would be recorded to the blockchain archive as immutable. A Block Proposer V1 is chosen by an algorithm to initiate the whole process. Roughly speaking, the consensus algorithm consists of the following steps: (1) V1 proposes the list of messages to be included into the new block and broadcast the block to all other VMs 131, (2) all participating VM 131 attest and vote on the validity of the block by comparing with the entries queued at the PMP 1113 of the local node, and (3) confirmation of the proposed block by V1. The details will be described in the consensus algorithm section later.

Block execution by BVM 1313—After the consensus algorithm determines that the block is immutable, all messages will be executed in the BVM 1313 by carrying out the pending transactions, schedules and smart contract deployment which will modify the state 13131 of the BVM.

Update of the BN history—all BHM 121 will incorporate the successful block into the ledger and update the blockchain history.

### Network Message Format

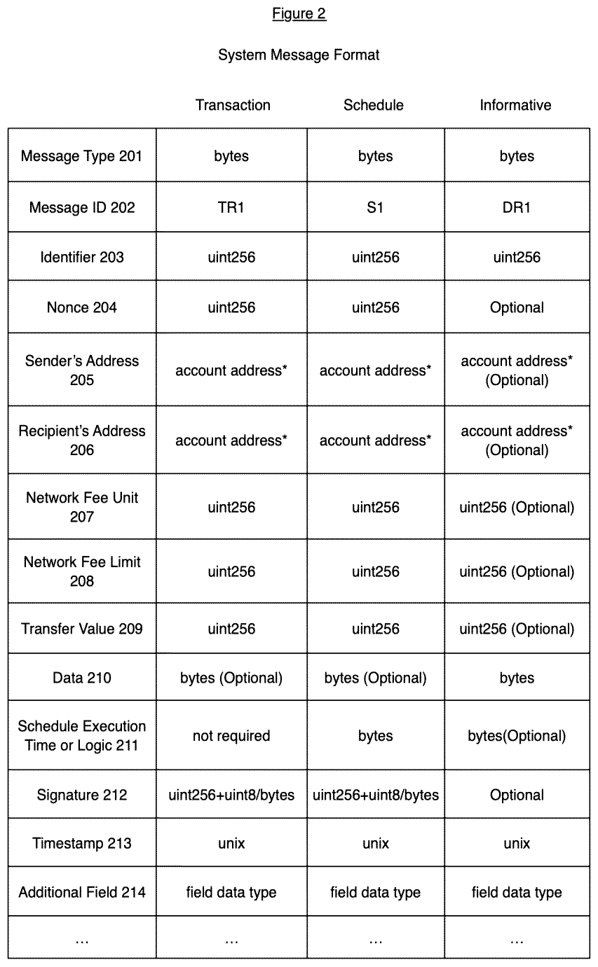

The End Users 105 and nodes can interact with the blockchain system via three basic types of operations, namely, Transaction Message, Schedule Message and Informative Message as described in FIG. 2. Each operation has its own data structure and function. Network messages go through compression or serialisation methods such as Recursive Length Prefix (RLP) and Application Binary Interface (ABI) before being broadcasted from End Users 105 to nodes and among the nodes. Other types of operation and message format can be defined when needed.

### Transaction Message

A Transaction Message is structured data that can immediately modify the account state of the Blockchain Virtual Machine 1313 (to be described later). In one embodiment, Transaction Messages can be generated by the End Users 105 or from the Schedule Messages (see below). Transaction Messages could be a transfer of value, smart contract creations and interactions, or virtual machine state modification.

The data structure for Transaction Messages are described in FIG. 2. Transaction Messages have fields including but not limited to Message Type 201, Message ID 202, Identifier 203, Nonce 204, Sender's Address 205, Recipient's Address 206, Network Fee Unit 207, Network Fee Limit 208, Transfer Value 209, Data 210, Signature 212 and Timestamp 213, and an optional Additional Field 214. In this system, Transfer Value 209 represents the amount of native network tokens to be sent, and Data 210 represents the bytecode for smart contract deployment or interaction with smart contract function.

### Schedule Message

A Schedule Message is structured data that instructs the Schedule Processing Unit 131322 to generate Transaction Messages. In one embodiment, Schedule Messages can be initiated by End Users 105 or by a smart contract to interact with the BN. The data structure for Schedule Messages are described in FIG. 2 have fields including but not limited to Message Type 201, Message ID 202, Identifier 203, Nonce 204, Sender's Address 205, Recipient's Address 206, Network Fee Unit 207, Network Fee Limit 208, Transfer Value 209, Data 210, Schedule Execution Time or Logic 211, Signature 212 and Timestamp 213, and an optional Additional Field 214.

In one embodiment, Schedule Messages can be categorised into Time Based Schedule Messages and Logic Based Schedule Messages. Schedule Messages have an additional field of Scheduled Execution Time and Logic 211 compared to Transaction Messages, which specifies the time or condition when a transaction indicated in the Schedule Message should be generated.

In one embodiment for Time Based Schedule Messages, End Users 105 are required to specify a time for execution in the future or a period between successive executions with a starting and ending time. The time is specified preferably in the format of Unix timestamp or IETF RFC3339 based on ISO8601. Once the system time exceeds the time for execution of a schedule, a Transaction Message would be generated. For example, if an organization desires to distribute a regular amount of Universal Basic Income (UBI) to eligible accounts, it can utilise Time Based Schedule Message to indicate the accounts, date, value and frequency of tokens to be distributed.

In one embodiment for Logic Based Schedule Messages, End Users 105 are required to specify a condition such as a comparison operation with a variable in the BVM State 13131. In a subsequent embodiment, Logic Based Schedule Message and Time Based Schedule Message can be combined into one Schedule Message.

In another embodiment, Schedule Message can be subsequently categorised into definite and indefinite schedules. Definite Schedule Messages have a finite active time and indefinite Schedule Messages can be perpetual. End Users 105 are required to specify one or more logic conditions such as a comparison operation with a variable in the BVM State 13131. When all conditions are met, a transaction would be generated. For example, a smart contract owner can specify that when the balance of a smart contract exceeds 10,000 tokens, the token will be equally distributed. Schedule Messages can be modified or deleted by the system at the request of the End User 105 by sending a Schedule Message to replace the current deployed Schedule Message.

### Informative Message

Informative Messages can be used to interact with the blockchain network, but they do not modify the state of the Blockchain Virtual Machine 1313. Informative Messages include but not limited to network communication messages, consensus protocol messages, data request and response messages, node protocol messages and control messages. In one embodiment, Informative Message can follow and expand on the existing or proposed standards such as the Ethereum Improvement Proposals listed in www.ethereum.org as the standard for Informative Messages and exchanges.

The basic parameters for Informative Messages are described in FIG. 2 and have data fields similar to Transaction Message and Schedule Message, except that most fields are optional, and a signature is not required. For non-broadcasted Informative Messages, an identifier is used to determine which message the blockchain is responding to. In one embodiment, the method field can be defined by the implementation to specify the type of Informative Messages available for End Users 105, including but not limited to balance retrieval, network fee estimation, code retrieval, transaction receipt request, and transaction by hash request.

Informative Messages can also be broadcasted. In one embodiment, broadcasted Informative Messages can be used by the VMs 103 when the consensus algorithm is being executed. First, a Block Proposer VM 103 is selected by an algorithm among all VMs 103. The Block Proposer VM 103 then generates a Proposed Block which is inserted into the Data field 210 and broadcast the Proposed Block to all other VMs 103 for voting. The Recipient's Address 206 can be represented by a special multicast address which indicates that all VMs 103 should receive the Proposed Block and take action. The other VMs 103 can reply to the voting request by unicasting Informative Message to the Sender's Address 205 of the Block Proposer VM 103 with the Identifier 203 of the original message to distinguish the message from others.

### Message Processing and Network Routing Module

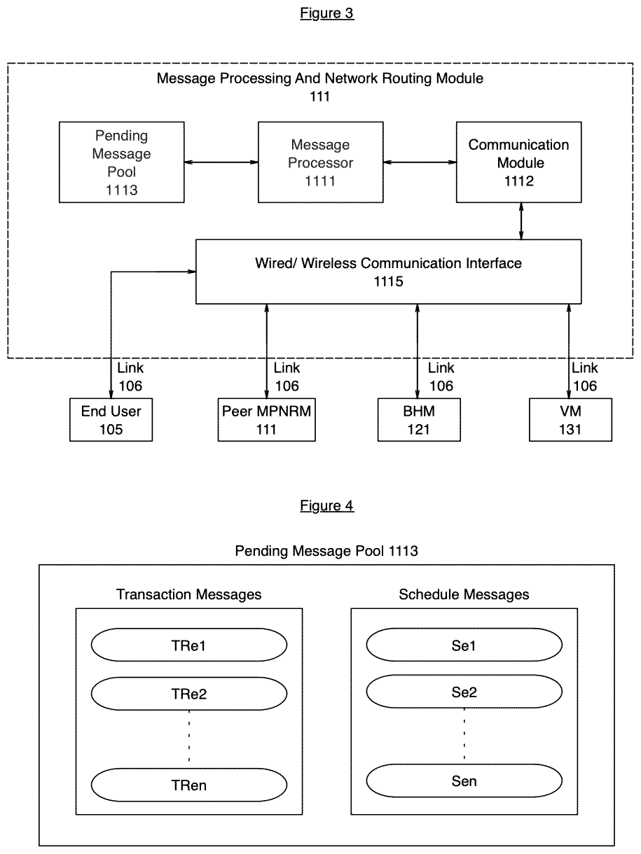

The MPNRM 111 as described in FIG. 3 is a digital electronic computing and communication system based on the IP protocol that determines actions on received messages and relays messages between nodes and modules. In one embodiment, the MPNRM 111 contains a Message Processor (MP) 1111, Communication Module (CM) 1112, Pending Message Pool (PMP) 1113, and Wired/Wireless Communication Interface (CI) 1114.

MP 1111 is a unit responsible for processing messages and discerning their immediate actions and subsequent states. Messages arriving at MP 1111 are processed based on their message format and signature validity.

CM 1112 decompresses or deserializes received messages from peer node or clients, converting them into a format suitable for processing in MP 1111. Additionally, CM 1112 also handles the serializing or compressing of message before broadcasting and transmitting them to other modules or nodes from MP 1111.

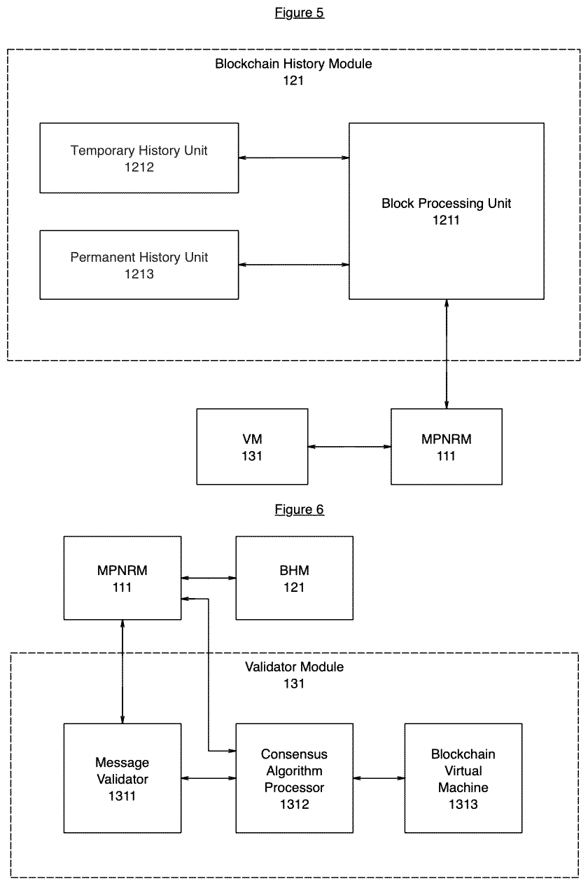

In one embodiment, PMP 1113 as described by FIG. 4 stores the pending Transaction Messages and Schedule Messages and sorts the messages according to their time of arrival. These messages will be included as part of the Proposed Block.

CI 1114 transmits serialised or compressed messages received from CM 1112 through Communication Links 106 to the other nodes, modules or clients.

In one embodiment, the MPNRM 111 can handle the following types of messages from the End Users 105, including but not limited to transaction requests, schedule requests, information requests, smart contract deployments and modifications, and consensus related messages. A message is first submitted by an End User 105 to the MPNRM 111 of any node for processing. For Transaction Messages, Schedule Messages, Smart Contract deployment and modifications, they are first verified to be valid and appended to the Pending Message Pool 1113 (PMP) for further processing. Informative Messages are handled by MPNRM 111 locally and returned with the intended data to the End User 105 without appending to the PMP 1113. Consensus related messages are communicated among the VMs 131 through the MPNRM. They will not be added to the PMP 1113.

After a new message is appended to the PMP 1113, the message will immediately be broadcasted to all other nodes directly connected to the node. The broadcast follows the gossip protocol (Kermarrec, 2007) to guarantee that every node connected to the network receive a copy of the new message. Message processing and broadcast are repeated recursively until all nodes in the network have received and validated the message and appended the message to its individual PMP 1113.

### Blockchain History Module

The Blockchain History Module 121 (BHM) as described in FIG. 5 is a memory unit for storing blockchain data that represents all the previous and current state of the Blockchain Virtual Machine 1313. The BHM 121 contains a Block Processing Unit (BPU) 1211, Temporary History Unit (THU) 1212 and Permanent History Unit (PHU) 1213.

The BPU 1211 is responsible for processing the latest block information from VM 131 and updating of THU 1212 and PHU 1213. THU 1212 stores the recent confirmed blocks and acts as a buffer to provide high transaction throughput. The data stored in THU 1212 is constantly requested so fast, dynamic memory is preferably used. Once the blocks in the THU 1212 reached a certain age or block number, they are removed from the THU 1212 and consolidated to the PHU 1213. The PHU 1213 provides long term storage for confirmed transactions and is organised in a blockchain format for immutability. Transactions are considered finalised once they are added to the Permanent History Unit 1213 by the Block Processing Unit 1211. Block Processing Unit 1211 also constantly synchronises its blockchain history with other peer BPUs 1211 and verifies the hash to ensure all blockchain history is up to date and authentic.

Peer MPNRM 111 and Validator Module 131 could request permanent or temporary blockchain information from the BHM 121 within the same node or from any peer nodes with BHM 121 using the Informative Messages.

### Validator Module

The Validator Module 131 (VM) as described in FIG. 6 is responsible for determining the validity of Transaction Messages and Schedule Messages for inclusion into the future blocks. In one embodiment, VM 131 contains a Message Validator (MV) 1311, Consensus Algorithm Processor (CAP) 1312, and Blockchain Virtual Machine (BVM) 1313.

MV 1311 is responsible for validating that each Transaction Message or Schedule Message included in the nearest future block is valid. Here valid means the transaction has all its field compliant with the blockchain network system along with an authentic signature.

Consensus Algorithm Processor 1312 (CAP) deploys the Consensus Algorithm which determines the next Proposed Block to be included in the BHM 121. CAP 1312 can also resolve discrepancy issues such as having two parallel blocks by adopting various consensus protocols such as CASPER the Friendly Finality Gadget (Buterin, V., & Griffith, V. (2017). Casper the friendly finality gadget. arXiv preprint arXiv:1710.09437.).

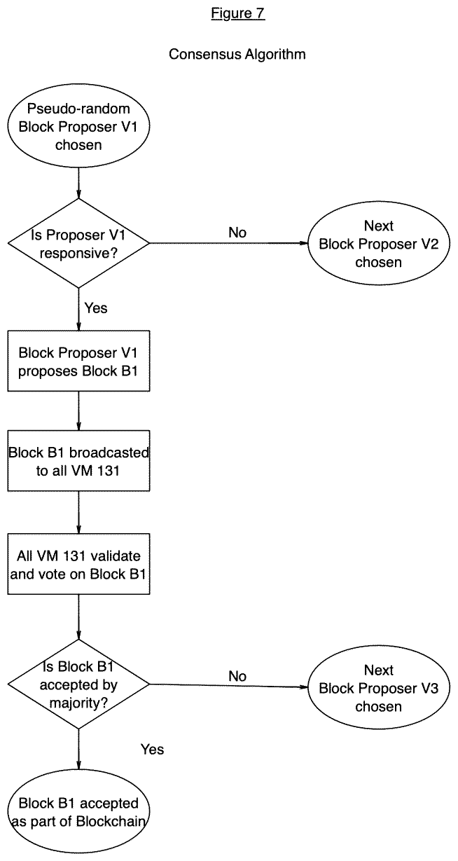

From time to time, a consensus algorithm as described in FIG. 7 is executed by a Block Proposer V1 to determine what messages stored at the PMP 1113 would be recorded to the BHM 121. Each successful execution of the consensus algorithm will result in a new block being accepted as immutable by the BHM 121. The time between two consecutive cycles of consensus algorithm can be chosen to optimize the delay and efficiency of the system. It is desirable to keep the delay it takes to confirm the pending transactions low, and to avoid too many unnecessary consensus algorithm cycles when the pending message pages have not yet been filled up. The typical duration between two consecutive executions of the consensus algorithms is measured in minutes and does not have to be constant.

In one embodiment, a Block Proposer V1 is selected by an algorithm to initiate the validating process. The algorithm can reside in CAP 1312 or in BVM 1313. The selection algorithm can be pseudorandom or truly random so the selection of the Block Proposer among all VMs 131 can be fair and transparent. The selection can depend on the system time or the current block number.

In general, the operation of the Consensus Algorithm consists of the following steps:

Selection of a Block Proposer V1—At regular time interval, a Block Proposer V1 is selected from all eligible VM 131 by an algorithm to serve as a proposer of a new block. The selection among all eligible is based on distributed algorithms such as random permutation based on some pseudorandom number generation algorithm. It the first selected Block Proposer V1 is unresponsive, the algorithm will select another Block Proposer V2.

Creation of a new Proposed Block by the Block Proposer V1-V1 creates a Proposed Block B1 based on the list of new messages received in the PMP 1113 including the Transaction Messages and Schedule Messages. Certain state information can also be included in the Proposed Block.

Broadcast of the Proposed Block 61 by V1 to all participating VMs 131.

Voting on the validity of Proposed Block B1—Each VM 131, upon receiving B1, will check on the validity of every Transaction Message and Schedule Message on B1 by comparing with the entries recorded in the local PMP 1113. If everything is valid, the VM 131 would reply to the Block Proposer to attest to the Block B1.

Confirmation of the Proposed Block B1 is broadcasted to all VMs 131 and BHM 121 if a ⅔ majority of affirmative votes is received by the Block Proposer V1. The ⅔ majority can be changed to other values.

The Confirmed Block B1 is established as an immutable part of the blockchain history and written into the THU 1212 of all BHMs 121. A selected BHM 121 will announce the new Block B1 to all nodes. The selection of the BHM 121 can follow a random or pseudorandom algorithm similar to the Block Proposer selection algorithm, The MPNRM 111 will purge from the PMP 1113 all the pending Transaction and Schedule Messages that have been recorded in the newly announced block.

The consensus algorithm cycle ends.

### Blockchain Virtual Machine

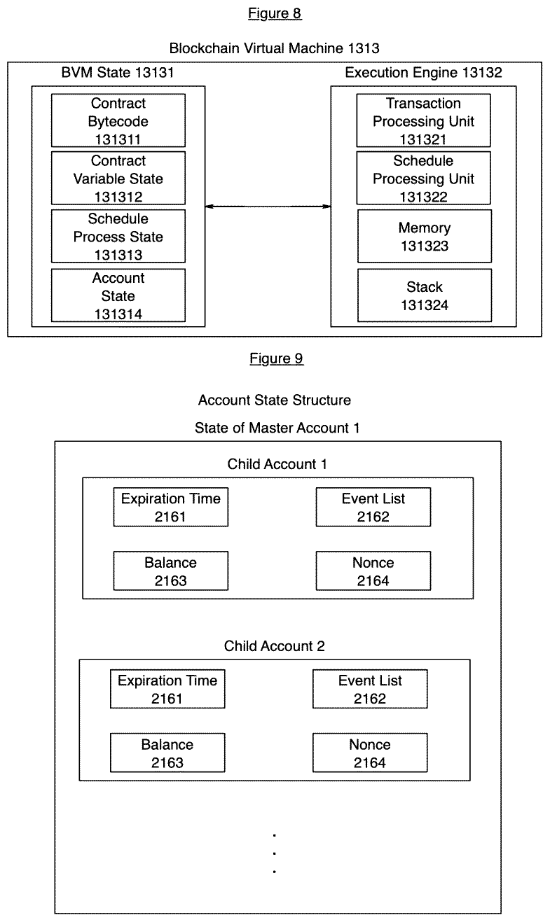

In one embodiment, the Blockchain Virtual Machine 1313 (BVM) as described in FIG. 8 is a deterministic sandbox execution environment containing a BVM state 13131 and Execution Engine (EE) 13132.

BVM state 13131 contains all the state information that uniquely determines how the system evolves and executes in the future. In general, the unique state information provides robustness and failure recovery for all blockchain networks, and consistency of the BVM state among various BVMs must be maintained. In one embodiment, the BVM state 13131 includes Contract Bytecode (CB) 131311, Contract Variable State (CVS) 131312, Schedule Process State (SPS) 131313 and Account State (AS) 131314. CB 131311 refers to all the compiled smart contract code currently deployed on the blockchain network. CVS 131312 refers to the current state of all the variables and data of all smart contracts. SPS 131313 refers to the current state of all processes corresponding to the Schedule Messages initiated by End Users 105 or converted from smart contracts. AS 131314 will be described below.

EE 13132 contains Transaction Processing Unit (TPU) 131321, Schedule Processing Unit (SPU) 131322, Memory 131323, and Stack 131324. TPU 131321 processes incoming Transaction Messages sequentially by accessing and modifying BVM state 13131. In one embodiment, a value transfer between two End Users 105 will result in a change of values of the user accounts in the BVM state 13131.

### Smart Contract to Schedule Message

In one embodiment, TPU 131321 can generate Schedule Messages according to instructions given in the smart contract. To deploy a smart contract, an End User 105 creates a Transaction Message TR_{SC} encapsulating the smart contract in the Data Field 210 and broadcast TR_{SC} to all nodes like a typical Transaction Message. TR_{SC} will be queued in the PMP 1113 in all MPNRM 111. As described above, TR_{SC} will be received by the VM 131 after the successful completion of a consensus algorithm cycle. VM 131 then passes TR_{SC} to TPU131321. Upon seeing TR_{SC}, TPU 131321 knows that it is a Smart Contract so its bytecodes will be written into CB131311 of the BVM state 13131. Then it will create a Schedule Message S_{SC} corresponding to TR_{SC}. S_{SC} will then be sent to a peer MPNRM for queueing and processing similar to a Schedule Message received from an End User 105.

### Handling of Schedule Messages by SPU 131322

In one embodiment, SPU 131322 processes the incoming Schedule Messages sequentially by generating one Schedule Process corresponding to each Schedule Message. After a new Schedule Process SP_{N} is created, the SPU 131322 will modify the SPS 131313 by creating a new entry for SP_{N} and writing down the values of all global variables employed by SP_{N} into the SPS 131313. SPU 131322 regularly checks that all processes set up are served properly. In one embodiment, a process can be woken up by SPU 131322 when the scheduled time is reached. In another embodiment, SPU 131322 can check all processes one by one in a round robin manner at regular intervals. The logic conditions set up for each process can also be checked when the process has been woken up and served by SPU 131322. When the time or logic conditions are satisfied, a Schedule Process may request SPU 131322 to generate Transaction Messages, for example, to effect a transfer of tokens from one account to another. The Transaction Messages so generated are sent to MPNRM 111 and processed according to the established procedures for handling Transaction Messages. Note that a Schedule Process can generate any number of Transaction Messages, whether fixed or indefinite. It is up to the End Users 105 or the smart contracts to specify.

Memory 131323 and Stack 131324 are used during the process of virtual machine opcode execution. Memory 131323 stores temporary data that is erased between transaction executions, and Stack 131324 manage execution data during smart contract interaction on a Last-In-First-Out principle.

SPU 131322 is assumed to be synchronised to the Internet time server with a variation smaller than a fraction of a second. Although operating independently, all SPU 131322 should arrive at the same state if time is synchronised.

### Account State 131314

In one embodiment, a novel account state structure can include an expiration time, event list, nonce and token balance for including smart contract generated tokens. The expiration time in the account state could be used to facilitate the creation of digital tokens with expiration time by providing a means to tracking expiration schedule of tokens in the account state. The event list be a data source for on chain and off-chain operations to call upon, providing additional layer of flexibility to smart contract and oracle node build upon the described blockchain network.

In one embodiment, a novel Account State 131314 is described in FIG. 9. A hierarchical deterministic account structure is used to facilitate the expiration function of the described blockchain network. When a user first sets up the wallet, a seed phrase, typically consisting of 12 or 24 words, is generated. This seed phrase is used to create a master private key, which serves as the root for generating multiple child private keys. Child Accounts are created from this single seed phrase through a process known as key derivation. Each child private key corresponds to a unique account with its own public address. These child accounts are deterministically derived from the master private key and an index number, allowing for the secure and organized management of multiple accounts within a single interface. The entire set of accounts can be backed up and recovered using the original seed phrase, providing both convenience and security. Child Accounts derived from the Master Account has its own Account State including an optional Expiration Time 2161, Event List 2162. Balance 2163 and Nonce 2164. Equivalently, an array of accounts can be used to represent the Master Account and its associated Child Accounts.

Expiration Time 2161 is an optional function which can be activated to set an expiration to all tokens in the account. In one embodiment, once the expiration time is reached, all tokens within the account are not transferable. In another embodiment, upon expiration, the tokens will be automatically transferred back to a repository that can be a fixed account address or the account address that generates the tokens. The usage of the Expiration Time 2161 feature will be discussed later.

Event list 2162 stores a list of historical events involving the child account, and includes the event type, event ID, timestamp, data, and signatures. After a Transaction or Schedule Message is processed by the BVM and accepted as part of the machine state, an event is generated and added to the event list 2162.

Balance 2163 stores all the token balances including native and smart contract derived tokens. The Balance 2163 is derived from the event lists pointed to by the Pointer 2162, storing all the updated balance from token transfers related to the account.

Nonce 2164 is a numerical counter stored in the Account State. It starts from zero and increments by one each time the account initiates a transaction or schedule. The nonce ensures the correct ordering of transactions and schedules and prevent replay attacks.

### Proposed Block B1

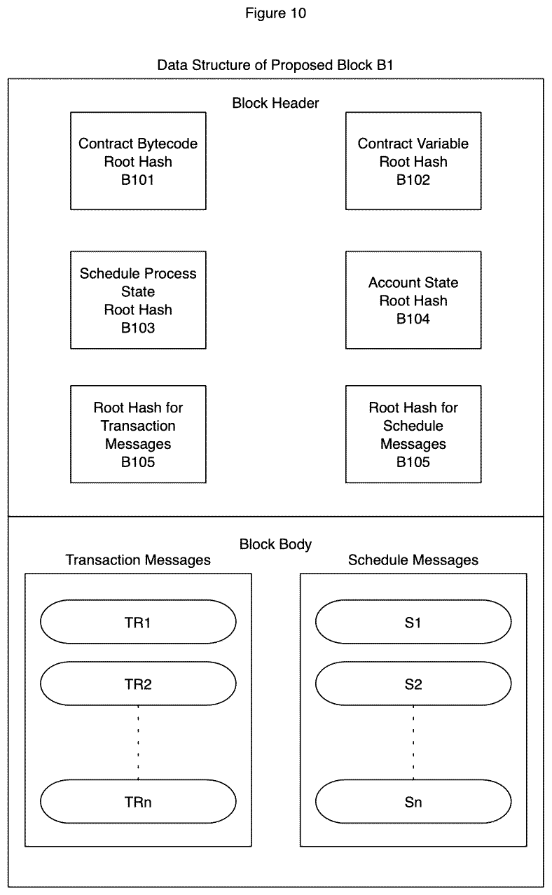

In one embodiment, the Proposed Block B1 as described in FIG. 10 is assembled by the Block Proposer V1 discussed previously. V1 requests and receives the list of messages queued at the Pending Message Pool 1113 from a local MPNRMP 111. V1 then validates the Transaction Messages and Schedule Messages and adds the hash root of each of the BVM state to B1 respectively. Transaction Messages and Schedule Messages are sorted according to their priority and filled into the Proposed Block B1 sequentially until the block is full.

### How End User Connect to the Nodes

In a preferred embodiment, end Users can utilize standard crypto wallet applications or programs to directly connect and communicate with nodes through a range of methods, including but not limited to JSON-RPC, Websockets, RESTful APIs, GraphQL and gRPC. End Users can choose their dedicated method to pass messages in the specified format described in FIG. 2 to available nodes and participate in the blockchain network.

Processing of Transaction Message TR1 submitted by End User

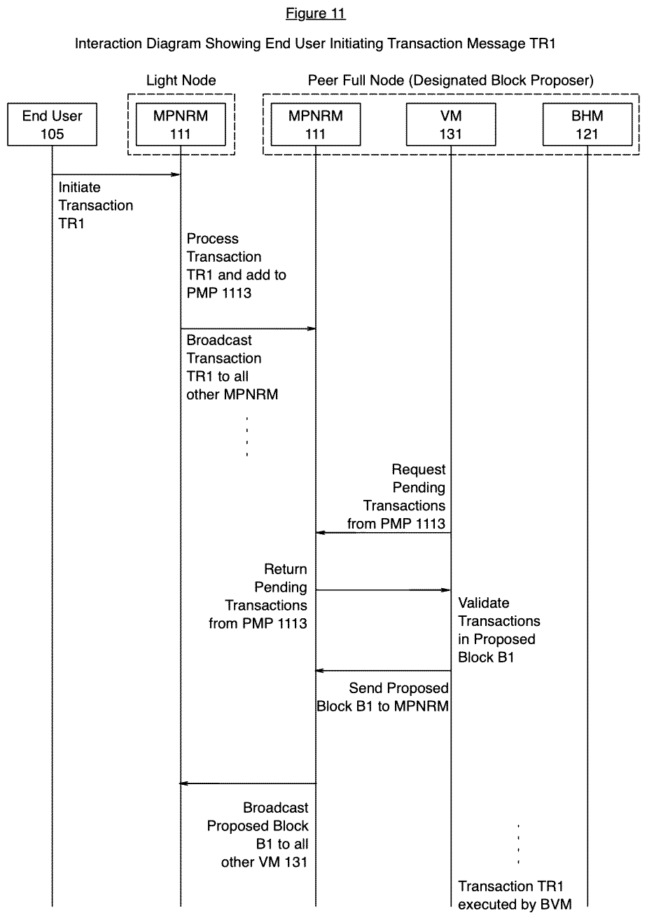

In one embodiment as shown in FIG. 11, a protocol diagram is shown to demonstrate how a new Transaction Message TR1 is processed by the various nodes in the system. An End User 105 (such as individuals with wallet application or decentralised app (DAPP) service providers) can send Transaction Messages to the blockchain anytime without scheduling.

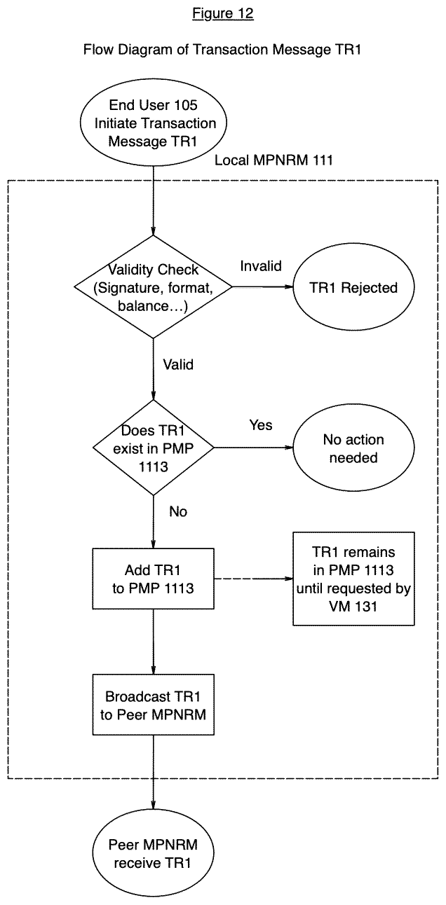

After End User 105 signed and initiated a transaction TR1, the transaction is processed as described in FIG. 12. MPNRM 111 that received TR1 performs a validity check on the message, including its signature, format, nonce and whether the balance of the account is sufficient. If TR1 is deemed valid, it is accepted into the PMP 1113 and broadcasted to all the other peer MPNRM 111. In another embodiment.

When a Block Proposer V1 initiates a new consensus algorithm cycle, TR1 is requested by the VM 131 and validated again. Unlike the first checking at the MPNRM 111, the validation will also check the account balance. That is, pending transaction messages can still be rejected at this stage to avoid double spending. The Proposed Block is then broadcasted to all nodes with VM 131 for voting. The Consensus Algorithm is then carried out by the CAP 1312 to determine if the Proposed Block containing TR1 is accepted by the BVM 1313 for actual processing. If the Proposed Block is accepted, all messages in the confirmed block will be processed by all BVMs 1313 one by one until completion.

### Processing of Schedule Message S1 Submitted by End User

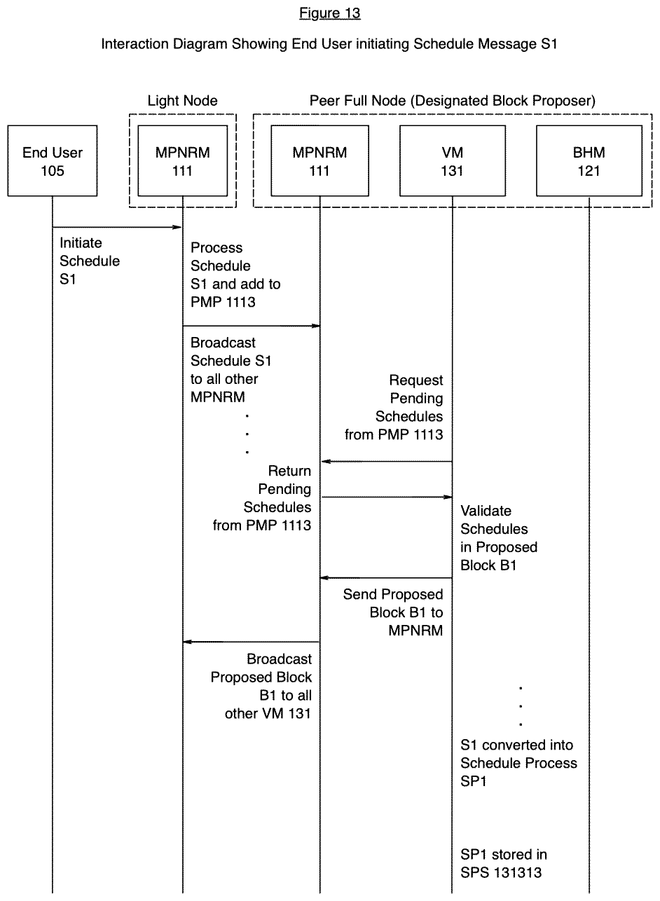

In one embodiment, as illustrated in FIG. 13, a protocol diagram is shown to demonstrate how a new Schedule Message S1 is processed by the various nodes in the system. An End User 105 (such as an individual with wallet application or a decentralised app (DAPP) service provider) can send Schedule Messages to the blockchain for time- or logic-based execution in the future.

In one embodiment, Schedule Messages are processed similar to the processing of Transaction Message TR1 until it reaches SPU 131322. After End User 105 initiated a Schedule Message S1 through the wallet, S1 is submitted to a connected MPNRM 111 (preferably closest in physical proximity) which checks on the validity of S1. S1 is then accepted into the PMP 1113 and broadcasted to all the other peer MPNRM 111.

When a Block Proposer V1 initiates a consensus algorithm cycle, S1 is included in the Proposed Block by the Block Proposer V1. The Proposed Block is then broadcasted to all VM 131 for voting. The Consensus Algorithm is then carried out by the CAP 1312 to determine if the Proposed Block containing S1 is accepted. If it is, S1 will be converted into Schedule Process SP1 and scheduled for execution by EE 13132. All Schedule Messages in the confirmed block will be processed by all BVMs 1313 one by one until completion.

### Processing of a Contract Schedule CS1 of an Autonomous Smart Contract

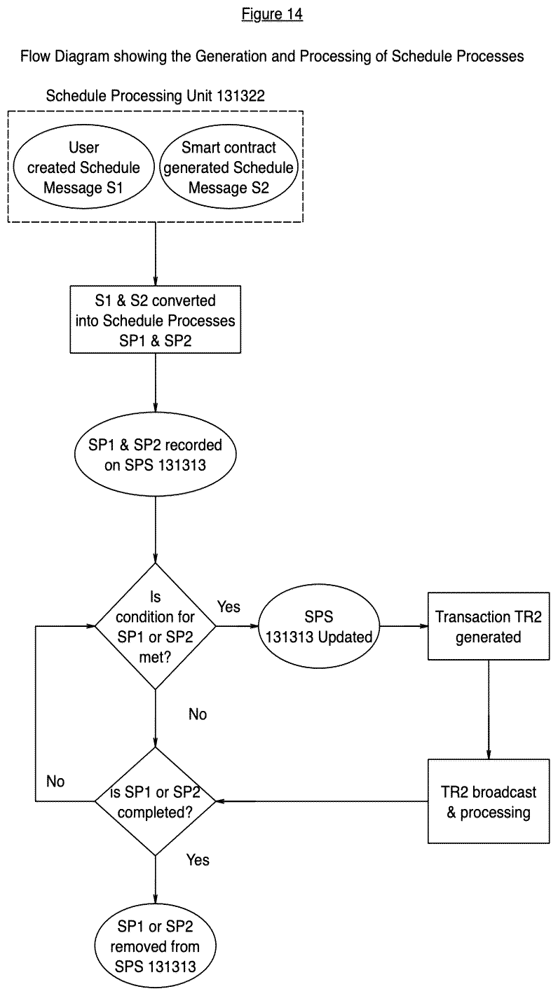

In FIG. 14, an Autonomous Smart Contract is shown to demonstrate the various kinds of schedules that can be used to automate the smart contract execution. Contract Schedule CS1 is a generalised form of Smart Contract Schedule 2121-2124? used in FIG. 14 for illustrating the automatic execution of a smart contract, utilising variable stored as contract state to a generate a Transaction Message interacting with the autonomous smart contract.

In FIG. 14, a protocol diagram is shown to demonstrate how a Contract Schedule CS1 is processed by the system. The initial process occurs in the Contract Schedule Interpreter 11142 which converts variables of the CS1 in form of machine code to a Schedule Message S2 according to system message format in FIG. 2. S2 is continuously monitored by Transaction Generator 11144 on whether CS1 is modified and condition for S2 is met. If CS1 variable is modified, a new Schedule Message S3 is generated by CS1 11142 to replace S2. If conditions for S2 is met and CS1 is not modified, a TR3 is generated by TG 11144 simultaneously in the SP 1114 of every MPNRM 111 and passed on to their PMP 1113 and processed in the same logic as TR1 submitted by an End User 105.

Conversion of Schedule S1 into Transaction TR2

If the condition such as time or logic is met for a schedule S1, a Transaction Message TR2 based on schedule S1 will be generated and processed in the same manner as TR1, and the process of TR2 generation is hereby described. After S1 is accepted as an immutable part of the blockchain history, it is stored in the User Generated Schedule 11143 as part of the Schedule State. When the condition for S1 generating a transaction is met, the process residing in the Schedule Execution Engine (SEE) 11141 would initiate a transaction according to the data stored?? on the schedule. A signature would then be put on to the generated transaction by the SP 1114 and broadcasted to peer nodes. The checking of conditions in SEE 11141 commence during every new?? block cycle after a new proposed block has been accepted by a VM and the block written into the BHM. New Transaction Messages can be generated by the processes in the SEE 11141 according to the Schedule Pool (ref number missing).

### Executing Smart Contract Functions Autonomously

A smart contract is a piece of executable code that can be compiled into bytecode and stored in the virtual machine of the blockchain. A variety of smart contract and virtual machine system have been deployed, for example, Solidity and the Ethereum virtual machine (EVM). In one embodiment, smart contract functions can be executed autonomously by setting up a Schedule Message. Automated contracts can carry out recurring tasks, updates, or transactions without external activation or approval, thereby enhancing the level of automation and reliability in the blockchain system. A dynamic, automated, and time-aware dimension is added to the system, broadening its potential applications in sectors like finance and the Internet of Things.

In another embodiment, a smart contract function can be attached optionally with time or logic conditions for triggering the corresponding function. The conditions are converted into Schedule Messages by the Schedule Processor 1114 and stored as Schedule State 131313 in the BVM.

### Cryptography

Multiple cryptographic standards such as the Elliptic Curve Digital Signature Algorithm (ECDSA) can be adopted in the implementation of the system. The transaction is signed using a private key associated with a participant's unique blockchain address, harnessing the ECDSA on the secp256k1 curve.

In scenarios wherein an entity wishes to validate or verify the authenticity of a transaction, the system is equipped to derive the participant's public key from the signature parameters (‘r’, ‘s’). By computing and comparing the generated Ethereum address from the public key with the transaction's originating address, the transaction's authenticity is ascertained.

Recognizing the diverse needs of modern digital infrastructures, this embodiment is not limited to the secp256k1 curve or Keccak-256 hashing. Instead, it is inherently adaptable and can seamlessly integrate with alternative cryptographic curves and hash functions that offer comparable security and efficiency standards, ensuring the system's longevity and relevance in an ever-evolving cryptographic landscape.

Furthermore, this novel blockchain system benefits from reduced susceptibility to collision attacks, enhanced transactional verification speeds, and an overarching increase in the security and reliability of the digital ledger.

It should be emphasised that while specific cryptographic standards and procedures have been detailed within this embodiment, the inventive core of the system lies in its adaptability, permitting the adoption and integration of other emerging or established cryptographic standards, thereby catering to an expansive range of application scenarios and ensuring long-term system robustness.

With these embodiments, the blockchain network system is enhanced with flexibility and automatic execution capabilities, enabling a wide range of applications, from automated financial transactions to decentralised scheduling systems to be realised.

Signatures of Schedule generated Transaction Message

Since the Transaction Message is not initiated by users directly, there are no signatures generated by the users who initiated the Schedule Message. Instead, a hash is generated through taking in the SHA-256 hash of the schedule state, the hash of the Schedule Message, and the transaction details, for nodes to verify whether the schedule generated Transaction Message is legitimate. Since the Schedule state is immutable, manipulation to Schedule generated Transaction Message will be rejected when it is verified.

### Expiration Time of Smart Contract Tokens

In one embodiment, the smart contract with the Schedule Message can be used to create digital tokens with expiration time. The expiration time of the transferred tokens can be reset to the original value upon each transfer. A renewal fee can be charged for every transfer. Digital tokens with expiration time can be used to reclaim the unused resources for redistribution. The renewal mechanism incentivises token circulation before expiration by setting up a penalty for token inactivity and accumulation. The sender and receiver of the token can be the same account. Both fungible tokens and non-fungible tokens can be equipped with an expiration time. Currently, there is no mechanism to retrieve any idle or unused digital tokens if the owner lost the private key or died in an accident without leaving a will.

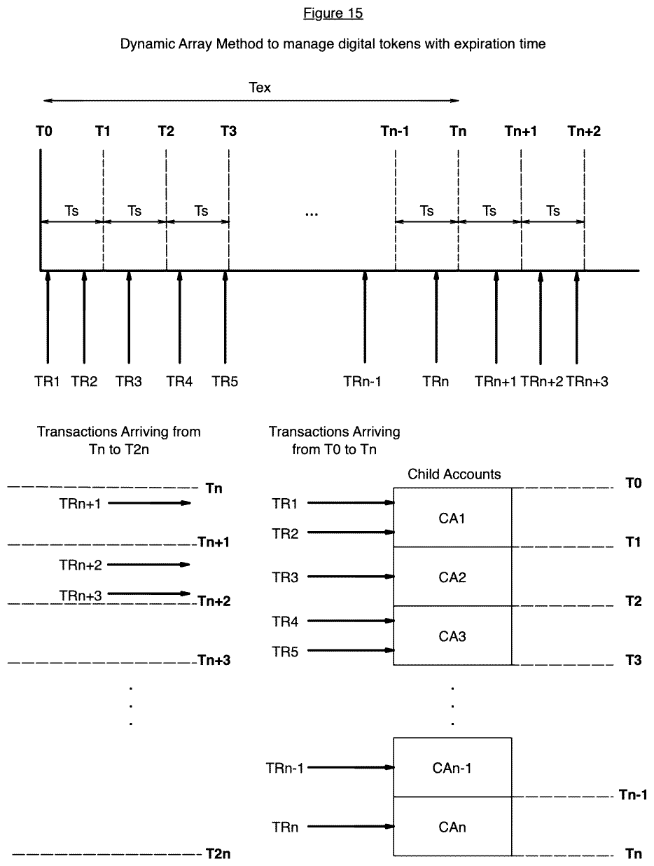

In another embodiment, a Dynamic Array Method to manage digital tokens with expiration time is described in FIG. 15. During each time period Tex, all of the incoming transactions are stored in the same Child Account such as TR1 and TR2 in CA1. All tokens in the same child account would have the same expiration time, such as T1 for CA1. After time T1, CA2 would be activated and operate similar to CA1. All the child accounts can be reused once the list of child accounts is exhausted.

### Direct Retrieval Method

In one embodiment called the Direct Retrieval method, the expiration time is realised by scheduling a token transfer back to a repository after a period of inactivity, effectively reclaiming the unused token from the account. Tokens can be automatically returned to the issuer or a specific account address after the expiration of the token. Schedule Messages can be initiated by a smart contract to schedule a transfer after the expiration time for all unused tokens back to its repository address where the account received the token from. For example, the smart contract can include the following pseudocode to realise the token expiration “if (block. Timestamp>=expirationTime) {//Logic to retrieve remaining tokens}.”

### Lock and Unlock Method

In another embodiment called the Lock and Unlock method, the expiration time can be used to limit the period that an account is allowed to transfer the token. That is, the user's actions can be restricted after the expiration time, such as freezing the transfer of tokens. In one embodiment, the user can unlock the frozen tokens through paying a penalty or renewal fee. The renewal fee can depend on the time interval between expiration and reactivation. The renewal fee can be a percentage of the expiring token value or fixed. The fee can be paid automatically. In another embodiment, the expiration time of tokens can be reset to the original value by automatically paying a renewal fee at the time of expiration.

### Dynamic Array Method

A main obstacle in realising a system of digital tokens with expiration time is how the system can remember which token is which that arrived at different times. Current cryptocurrency systems like Bitcoin employ fungible tokens which do not have a property tag associated with each individual token. Another problem is that a token can be infinitely divisible. Therefore, it is impossible to associate an expiration time parameter with a token.

In one embodiment called the Dynamic Array method, a dynamic array of accounts can be used to keep track of the expirable tokens received at different times. The dynamic array can use an array of child accounts generated from a master account as shown in FIG. 9. The array of child accounts can be circularly linked together as shown in FIG. 15. Each child account can receive tokens that arrive within the same time period and these tokens will expire at the same time. For example, assuming an array of twelve child accounts and an expiration time T_{EX} of one year, one child account can be used to receive tokens arriving within any given month. After one year, any unused tokens remaining in that child account can be frozen as described in the Lock and Unlock method. In another embodiment, the frozen child account can be renewed by paying a renewal fee automatically. This way, the Dynamic Array method and the array of child accounts can be used continuously to realise a blockchain network system with expirable tokens. Tokens can be received, transferred or expired (and automatically renewed) like a regular cryptocurrency system. The expiration time can be one day, one week, one month, three months, six months, one year or multiple years. When the expirable token is transferred from one account to another, a renewal fee must be paid to reset the expiration time. The renewal fee can be fixed or be a percentage of the transfer value. When the renewal fee is a percentage of the transfer value, the percentage is called the Retrieval Rate.

In one embodiment, the percentage can be chosen to be identical to the value added tax (VAT) which can facilitate the collection of VAT. The retrieval rate can be changed at any time while the system is in operation. The provision offers a novel way for the government to collect taxes from cryptocurrency transactions. The rate can be adjusted as needed.

### Regenerative Universal Basic Income (RUBI)

In one embodiment, a novel type of digital token called Regenerative Universal Basic Income (RUBI) can be created by implementing one of the expiration time mechanisms such as the Dynamic Array method with Retrieval Rate to claw back a certain percentage of tokens to the repository for every transfer. This retrieval rate is analogous to the value added tax in the current taxation system that guarantees the recirculation of the tokens. The combination of expiration time and Retrieval Rate on digital tokens can create a recirculating stream of RUBI for redistribution to a portion or all users indefinitely. Individuals receiving the RUBI can be given a time limit (for example six months or one year) to spend their RUBI, in which a percentage or Retrieval Rate, say for example 5 percent of the transferred value is retrieved to the RUBI distribution repository. The expiration time limit of the transferred RUBI will be reset after every transfer. If the RUBI is not spent entirely within the time limit, the unspent portion would be retrieved automatically by the smart contract that generate the RUBI. In another embodiment, the unspent portion can be automatically renewed for another expiration period by paying the renewal fee. The renewal fee can be the same as the Retrieval Rate for simplicity of management.

Hence, the tokens would be forced to circulate under the Expiration Time mechanism and a portion will always be retrieved back to the issuer during circulation by the Retrieval Rate mechanism. The retrieved RUBI will be redistributed without the need to create additional supply of RUBI. In one embodiment, retrieved RUBI can be automatically distributed to a portion or all eligible accounts, evenly or weighted, according to some pre-determined formulae. In another embodiment, the retrieved RUBI can be returned to the repository for redistribution.

### Automatic Periodic Increment or Decrement in Token Amount

In another embodiment, the smart contract with the Schedule Message can be used to create digital fungible tokens with an automatic periodic increment or decrement in the amount of tokens by storing a rate parameter as a state variable of the system. The rate is modifiable and can be positive, negative or zero. A schedule message can be used to transfer newly generated tokens to selected accounts, or retrieve existing tokens from selected accounts back to the issuer, in proportion to the amount of tokens held by each account. The amount of fungible tokens generated or retrieved is dependent on the rate parameter defined in the smart contract which can be changed from time to time.

The increment and decrement can be carried out automatically and periodically by the Schedule Message. For example, if the increment is 10% for every year, each account would receive an additional (account token amount*10%/365) tokens per day, and vice versa for retrieval of tokens from the accounts. This is not possible with existing cryptocurrencies since smart contract have no custody over distributed tokens, and smart contract cannot initiate any transactions. The automatic periodic increment can imitate interest generation for fixed deposit in the banks, and the automatic periodic decrement can serve as a negative interest rate tool for central bank authorities. The period can be a variable, from a minimum of one day to one week, one month, three months, one year or multiple years. The daily automatic increment or decrement imitates the overnight interest rate for bank deposits.

### Automatic Settlement of Financial Derivative Tokens (FDTs)

In one embodiment, fungible or non-fungible digital tokens with expiration time can be used to create Financial Derivative Tokens (FDTs) which is analogous to options, futures, forwards, swaps, warrants, and hybrid derivatives in the financial market. Financial contracts are usually settled through a series of well-defined process involving various entities including the parties to the contract, intermediaries and regulatory bodies. The complex process can be replaced by a single Schedule Message which calculates the contract value and automatically proceeds with the settlement at the scheduled time or logic conditions accordingly.

Digital tokens with an expiration time can have its value calculation formula (such as Black-Sholes formula for European-style options) encoded in the contract, and individuals can trade and settle the FDTs in a trusted, transparent and decentralised manner without intermediaries. FDTs can be automatically settled by scheduling a contract settlement which execute contract value calculation function at the expiration lire. In another embodiment, a system for managing the FDTs is described, with functions including creation, modification and cancellation of FDTs, trading, price discovery, statistics gathering, trusted proxy for traders, insurance, and legal compliance. This system offers a transparent, open, decentralised, robust, secure and trusted trading environment for FDTs.

In the above descriptions, capital letter terms (which are usually followed by a reference number with respect to one or more of the figure drawings) are used to refer to specific terms and concepts within the described blockchain network and are distinguished from the general term with the same spellings commonly used in describing other blockchain networks, although the functionality or concept behind these capital letter terms may overlap partially with existing blockchain network terms.

The various embodiments, implementations, features and aspects of the invention noted above can be combined in various ways or used separately. Those skilled in the art will understand from the description that the invention can be equally applied to or used in other different settings with respect to various combinations, embodiments, implementations or features provided in the description herein.

The invention can be implemented in software, hardware or a combination of hardware and software. A number of embodiments of the invention can also be embodied as computer readable code on a computer readable medium. The computer readable medium is any data storage device that can store data which can thereafter be read by a computer system. Examples of the computer readable medium include read-only memory, random-access memory, CD-ROMs, magnetic tape, optical data storage devices and carrier waves. The computer readable code is stored and executed in a distributed fashion.

Numerous specific details are set forth to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well known methods, procedures, components and circuitry have not been described in detail to avoid unnecessary obscuring aspects of the present invention.

In the foregoing description, reference to “one embodiment” or “an embodiment” means that a particular feature, structure, or characteristic described in connection with the embodiment can be included in at least one embodiment of the invention. The appearances of the phrase such as “in one embodiment”, “in another embodiment”, “in a following embodiment”, “in a subsequent embodiment” and “in a related embodiment” in various places in the specification are not necessarily all referring to the same embodiment, nor are separate or alternative embodiments mutually exclusive of other embodiments. Further, the order of blocks in process flowcharts or diagrams representing one or more embodiments of the inventions do not inherently indicate any particular order nor imply any limitations in the invention.

The many features and advantages of the present invention are apparent from the written description and, thus, it is intended by the appended claims to cover all such features and advantages of the invention. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

What is claimed is:

1. A system for decentralized message scheduling in a blockchain network, the system comprising: a blockchain network with a multitude of nodes interconnected and interoperable together;
at least two validator nodes;
at least two archive nodes;
at least one processor in each of the at least two validator nodes;
at least one storage device in each of the at least two validator nodes that stores at least executable computer programme code that when executed by the at least one processor in each of the at least two validator nodes can serve as a decentralised message scheduling system which allows one or more transactions to be executed in the future when certain time or logic conditions, or both conditions, specified by user applications are satisfied, by causing the at least one processor in each of the at least two validator nodes to:
receive a schedule message,
validate the schedule message,
broadcast the schedule message to each of the at least two archive nodes for recording,
create a process to monitor the certain time or logic conditions, or both conditions, that are specified by the schedule message,
generate one or more transaction messages from the schedule message when the certain time or logic conditions, or both conditions are satisfied,
submit the one or more transaction messages to one of the at least two validator nodes for transaction processing and execution, and
terminate the process and remove the schedule message,
wherein the schedule message contains instructions to generate one or more transactions to be executed in the future when certain time or logic conditions, or both conditions, specified by the user applications are satisfied, and
wherein all schedule messages that are recorded in the archive nodes are immutable.

2. The system as recited in claim 1,
wherein the schedule messages that are recorded in the archive nodes can be inspected by the users, or user applications.

3. The system as recited in claim 1,
wherein the schedule messages can be amended or deleted by the user applications.

4. The system as recited in claim 1,
wherein the one or more transactions to be executed in the future can be deployed by schedule messages from the user applications.

5. The system as recited in claim 1,
wherein the schedule messages can be generated by the decentralized message scheduling system.

6. The system as recited in claim 1,
wherein the blockchain network system can interwork and maintain compatibility with the existing cryptocurrency systems, including Bitcoin, Ethereum and Solana.

7. The system as recited in claim 1,
wherein the user application can be a cryptocurrency wallet or a smart contract.

8. The system as recited in claim 7,
wherein the smart contract can be self-invoking.

9. The system as recited in claim 8,
wherein the schedule messages can be deployed by the users directly or generated by the smart contracts residing in the blockchain network nodes.

10. The system as recited in claim 9,
wherein digital tokens with an expiration time can be generated by deploying a smart contract with schedule messages.

11. The system as recited in claim 10,
wherein the expired tokens remain locked in the account but cannot be transferred.

12. The system as recited in claim 11,
wherein the locked expired tokens can be unlocked by paying a renewal fee,
wherein the new expiration period for the unlocked tokens is reset to the original expiration time period.

13. The system as recited in claim 10,
wherein the expired tokens are transferred back to the originating account or a central repository.

14. The system as recited in claim 10,
wherein a certain amount of fungible tokens with a fixed expiration period are generated in a central repository by a smart contract,
wherein a portion of the certain amount of expirable tokens are distributed at regular intervals to the accounts of some or all users as universal basic income with the token expiration period reset to the original expiration period before distribution,
wherein a certain processing fee or transaction tax, or both, is incurred on all token transfers or transactions among different accounts,
wherein the certain transaction tax so collected in the form of tokens is returned to the central repository,
wherein unspent but expired tokens in all user accounts are automatically returned back to the central repository,
wherein all transferred or returned tokens can have the expiration time reset to the original value for redistribution, and
wherein the operation of the universal basic income system can be sustained without continuous injection of tokens.

15. The system as recited in claim 14,
wherein the unspent but expired tokens in user accounts can be automatically renewed by resetting the expiration time to the original value upon paying a transaction tax.

16. A non-transitory computer-implemented method for managing decentralized schedule messages that represent transactions to be executed in the future on a blockchain network with a multitude of nodes including at least two validator nodes and at least two archive nodes which allows user applications to interact with the blockchain network nodes, comprising:
creating a computer process running in each of the at least two validator nodes to receive and process schedule messages;
receiving a schedule message by a node and placing it in the pending message pool;
broadcasting the schedule message to all other nodes;
selecting periodically a validator node as the new block proposer;
creating a new block by the new block proposer including all messages in the pending message pool;
proposing the new block that contains the schedule message by the block proposer to all other validator nodes;
receiving confirmation of the new block by a majority of validator nodes;
writing the new block into all archive nodes and incorporating the new block into the immutable archive record;
removing all messages that appeared in the new block from the pending message pools residing in all nodes;
generating and running a concurrent schedule process for the schedule message by the said computer process in each of the at least two validator nodes;
checking on the schedule process periodically to determine if certain user defined time and logic conditions are satisfied and executing the schedule process if the conditions are satisfied;
generating one or more transaction messages from the schedule process when certain user defined time or logic conditions, or both conditions are satisfied;
submitting the one or more transaction messages to a node and executing them immediately; and
terminating the concurrent schedule process when the work is completed, wherein the schedule message can be generated by a user application or a smart contract.

17. A non-transitory computer-implemented method for managing decentralized schedule messages as recited in claim 16,
wherein the schedule message is generated by a smart contract for fungible tokens, wherein a portion of the fungible tokens are distributed to all accounts according to a pre-determined formula,
wherein the schedule message can either distribute additional fungible tokens to all accounts, or retrieve fungible tokens back from each account, at regular intervals in proportion to the amount of fungible tokens being held in each account, and wherein the amount of additional fungible tokens distributed or retrieved is dependent on a rate parameter defined in the smart contract that can be changed from time to time.

18. A non-transitory computer-implemented method for managing decentralized schedule messages as recited in claim 16,
wherein the schedule message is generated by a smart contract for fungible tokens,
wherein the fungible tokens have an expiration time,
wherein the expiration time of the tokens can be reset by transferring a percentage (R1) of the tokens to an account defined by the smart contract,
wherein the schedule message can effect an automatic transfer of all expired tokens back to the smart contract account if the expiration time is not reset, and
wherein the schedule message can effect a transfer of a percentage (R2) of the expirable tokens involved in every transaction to the smart contract account and reset the expiration time of the tokens after the transaction.

19. A non-transitory computer-implemented method for managing decentralized schedule messages as recited in claim 16,
wherein the schedule message is generated by a smart contract for non-fungible tokens,
wherein the non-fungible tokens have an expiration time, and
wherein the schedule message created for different non-fungible tokens represents a different financial contract including options, futures, forwards, swaps, warrants, and hybrid derivatives in the financial market.

20. A non-transitory computer-implemented method for generating digital tokens with expiration time on a blockchain network with a multitude of nodes including at least two validator nodes and at least two archive nodes which allows user applications to interact with the blockchain network nodes, comprising:
setting an expiration time parameter;
deploying a smart contract by a user application that generates a number of digital tokens in a repository account;
obtaining a list of recipient accounts from the smart contract;
distributing the generated tokens to the recipient accounts;
generating schedule messages for each recipient account that can cause the generation of transaction messages when the expiration time is reached; and
generating the transaction messages that cause the transfer of tokens remaining in each recipient account back to the repository account when the expiration time is reached,
wherein the schedule messages are generated by a decentralised schedule message system, and
wherein the schedule messages are recorded in each of the at least two archive nodes.
